(19) United States
(12) Patent Application Publication
(10) Pub. No.: US 2017/0043673 A1
(43) Pub. Date: Feb. 16, 2017

(54) CHARGING DEVICE FOR ECO-FRIENDLY VEHICLE

(71) Applicants: Hyundai Motor Company, Seoul (KR); Kia Motors Corporation, Seoul (KR)

(72) Inventors: Jae Won Lee, Hwaseong (KR); Young Kook Lee, Seoul (KR); Dong Jun Lee, Suwon (KR)

(21) Appl. No.: 14/964,845

(22) Filed: Dec. 10, 2015

(30) Foreign Application Priority Data
Aug. 11, 2015 (KR) 10-2015-0112884

(51) Int. Cl. B60L 11/18

(52) U.S. Cl. CPC B60L 11/1838

(57) ABSTRACT

A charging device for a vehicle is provided to charge a vehicle battery by power supplied from electric vehicle supply equipment (ESVE). The device includes a built-in circuit for embodying a scheduled charging function. Particularly, a circuit controls a power supply of a first controller turning the charger on and off based on a property of a CP signal applied when connected to the EVSE to reduce regular current consumption of the charger. In other words, the circuit detects a control pilot (CP) signal and performs a scheduled charging to allow the charger to adjust the power supply of a charger controller to be turned on/off based on a property of the CP signal and a scheduled charging function is performed, thereby reducing regular current consumption.

### CROSS-REFERENCE TO RELATED APPLICATION

This application claims under 35 U.S.C. §119(a) the benefit of Korean Patent Application No. 10-2015-0112884 filed on Aug. 11, 2015, the entire contents of which are incorporated herein by reference.

### BACKGROUND

(a) Technical Field

The present disclosure relates to a charging device for a vehicle that charges a battery in the vehicle by power supplied from a power supply disposed extraneous to the vehicle and, more particularly, to a charging device for a vehicle having a built-in circuit which embodies a scheduled charging function, thereby reducing normal current consumption.

(b) Background Art

Generally, an eco-friendly vehicle such as an electric vehicle (EV) or a plug-in hybrid electric vehicle (PHEV) is equipped with an on-board charger (OBC) which uses power from electric vehicle supply equipment (EVSE) disposed extraneous to the vehicle to charge a battery used as a power supply of a driving motor.

Normally, when a connector of the EVSE is connected to charge the battery when an engine of the vehicle is turned off, a power supply of a control circuit in the OBC needs to be turned on. Therefore, a control power supply (e.g., a power supply of the control circuit) is turned on/off or a scheduled charging function is performed using a control pilot (CP) signal input from the EVSE. Accordingly, in the relate art, a conical unit (OBC CPU) in the OBC operates to monitor a CP signal and to manipulate the power supply of the control circuit or allows the OBC to be operated by an external controller based on the state of the CP signal.

Even though a controlling technique described above may be implemented, the battery of the vehicle is consumed by using the power supply of the control circuit, and accordingly the increased number of charging the battery may shorten electricity efficiency (e.g., a trip distance compared with a quantity of charged electricity) or fuel efficiency.

The above information disclosed in this section is merely for enhancement of understanding of the background of the invention and therefore it may contain information that does not form the prior art that is already known in this country to a person of ordinary skill in the art.

### SUMMARY

The present invention provides a charging device for a vehicle including a built-in circuit for embodying a scheduled charging function that may include a circuit configured to adjust a power supply of a first control unit (OBC CPU or first controller) configured to operate a charger (OBC) to be turned on/off based on a property of a control pilot (CP) signal applied when connected to electric vehicle supply equipment (EVSE) disposed extraneous to a vehicle, thereby reducing regular current consumption of the charger (OBC).

In other words, in the present invention, a circuit configured to detect the CP signal and perform a scheduled charging function is provided in the charger (OBC), to allow the charger (OBC) to adjust the power supply of the control unit (OBC CPU) in the OBC to be turned on/off solely based on the property of the CP signal and perform the scheduled charging function, thereby reducing the regular current consumption.

In one aspect, the present invention provides a charging device for a vehicle having a built-in circuit which embodies a scheduled charging function supplied with power from electric vehicle supply equipment disposed extraneous to the vehicle to charge a battery mounted within the vehicle, the charging device may include: a second power supply turned on when a control pilot (CP) signal is input from the electric vehicle supply equipment; a second control unit (e.g., second controller) configured to operate by receiving the power from the second power supply and adjust a first power supply to be turned on or off; a first power supply turned on by the second controller to turn on the first controller; and a first controller turned on by the first power supply and configured to output a control signal related to on or off control of the first power supply to the second controller.

In an exemplary embodiment, the second controller may include a scheduled charging logic unit configured to detect a property of the CP signal input from the electric vehicle supply equipment to output a signal related to the on/off control of the first power supply; a memory circuit unit configured to receive a control signal of the first controller unit to output a signal for executing a signal selecting operation of a signal converting unit and a signal related to the on/off control of the first power supply; and a signal converting unit configured to receive an output signal of the scheduled charging logic unit and the memory circuit unit to output a signal to turn on/off the first power supply.

In another exemplary embodiment, the memory circuit unit may include a first command transmitting circuit unit configured to receive a control signal of the first controller to output a signal for executing a signal selecting operation of the signal converting unit; and a second command transmitting circuit unit configured to receive the control signal of the first controller to output a signal for executing the first power supply to be on/off.

In still another exemplary embodiment, when the memory circuit unit initially operates, the first command transmitting circuit unit and the second command transmitting circuit unit may be set to output a high signal to the signal converting unit to turn on the first power supply. In addition, when the first power supply is maintained to be in an on state for a predetermined time or longer, the first controller may be configured to input a control signal for allowing the signal converting unit to select an output signal of the scheduled charging logic unit to the second command transmitting circuit unit and the scheduled charging logic unit may be configured to output a low signal by the property of the CP signal.

When the signal converting unit is connected to the scheduled charging logic unit and the CP signal with a property of a square wave is applied, to allow the scheduled charging logic unit to output a high signal, the signal converting unit may be configured to output a high signal to turn on the first power supply. The scheduled charging logic unit may be configured to output a high signal when the CP signal is a square wave, using a high signal detecting unit and a low signal detecting unit configured to detect signals in different states when the CP signal is input.

Further, the scheduled charging logic unit may include a high signal detecting unit configured to output a HIGH output when a HIGH signal of the CP signal is input, a low signal detecting unit configured to output a HIGH output when a LOW signal of the CP signal is input, and an AND gate configured to output a HIGH signal when both outputs of the high signal detecting unit and the low signal detecting unit are high. The signal converting unit may be configured to select any one of the output signal of the second command transmitting circuit unit and output signal of the scheduled charging logic unit by a signal input from the first command transmitting circuit unit, and output a signal for an on/off operation of the first power supply by the selected output signal.

According to the present invention, when the CP signal is input from the external electric vehicle supply equipment (EVSE) without having a regular operation of a first controller mounted in the charger (OBC) installed within the vehicle or applying an external controller, the charger (OBC) may be configured to adjust the power supply of the first controller to be on or off based on the property of the signal and perform the scheduled charging mode, to reduce a dark current of the charger (OBC) in the scheduled charging mode (or a charging standby state). Therefore, fuel efficiency and electricity efficiency of the vehicle may be improved and operational reliability of the charger (OBC) may be improved by a rapid response speed and a stable operation characteristic. According to the present invention, an external controller may be omitted, and thus, an unstable operation due to failure of the external controller may be removed.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIGS. 1 and 2 are views illustrating a charging device for a vehicle according to an exemplary embodiment of the present invention;

FIG. 3 is a schematic view illustrating a CP signal input to a charging device for a vehicle, an on/off operation of a first power supply based on a property of the CP signal, and a state of an output signal and a feedback signal of a first controller according to an exemplary embodiment of the present invention;

FIG. 4A is a view illustrating a configuration of a second controller of a charging device for a vehicle according to an exemplary embodiment of the present invention;

FIG. 4B is a view illustrating an output signal and a feedback signal of a first controller according to an exemplary embodiment of the present invention;

FIGS. 5A and 5B are exemplary views illustrating a circuit configuration of a scheduled charging logic unit of a charging device for a vehicle according to an exemplary embodiment of the present invention;

FIG. 6 is a function table which is applied to first and second flip flops of a charging device for a vehicle according to an exemplary embodiment of the present invention;

FIGS. 7 and 8 are exemplary views illustrating a circuit configuration of a command transmitting circuit unit which constitutes a memory circuit unit according to an exemplary embodiment of the present invention;

FIG. 9 is a function table which is applied to first and second flip flops of a charging device for a vehicle according to an exemplary embodiment of the present invention; and

FIGS. 10 and 11 are views illustrating a charging device for a vehicle of the related art.

Reference numerals set forth in the Drawings includes reference to the following elements as further discussed below:

100: charging device

110: second power supply

120: second control unit

122: scheduled charging logic unit

124: memory circuit unit

126: signal converting unit

130: first power supply

140: first control unit

200: electric vehicle supply equipment (EVSE)

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to the limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

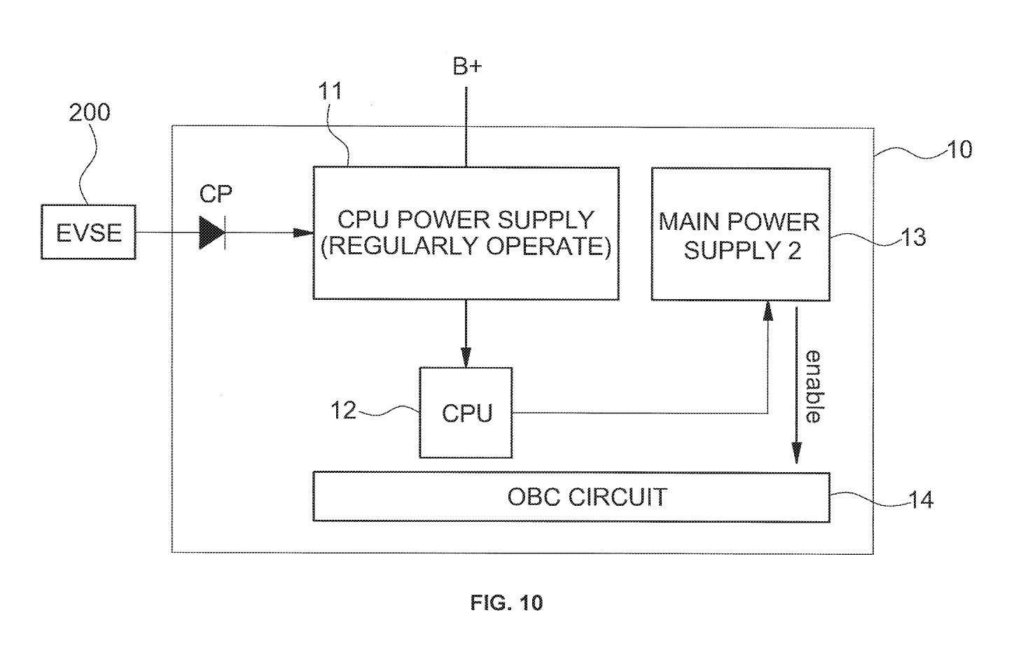

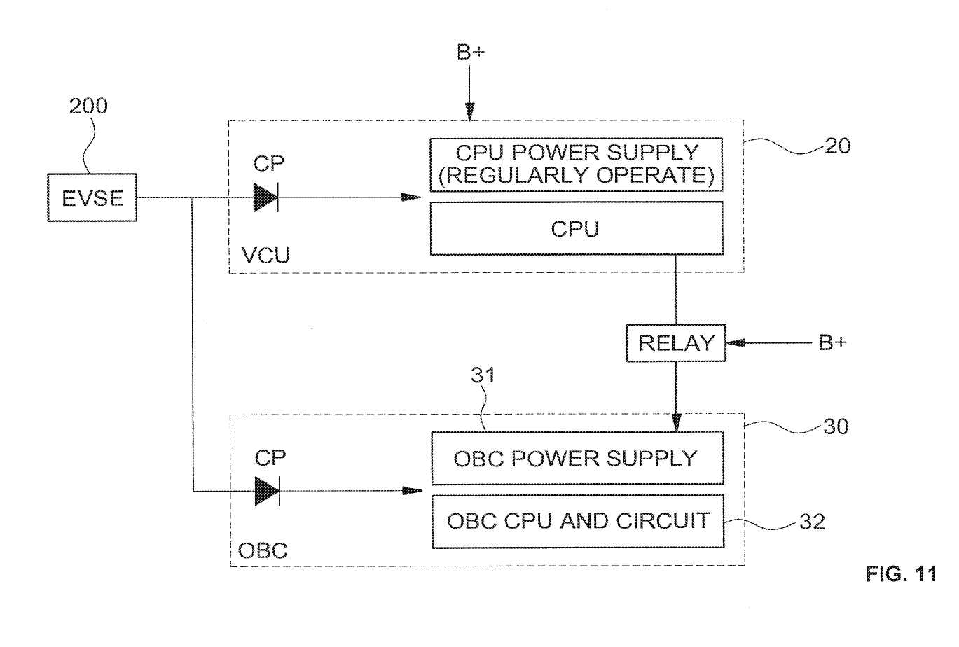

First, referring to FIGS. 10 and 11 according to the related art, in charging devices 10 and 30 for a vehicle used in general, to turn the charger (OBC) on and off based on a CP signal condition, the control unit (OBC CPU) in the OBC operates normally (e.g., without error) or another external controller 20 monitors the CP signal to turn the power supply of the charger OBC on and off. Specifically, as illustrated in FIG. 10, the controller power supply 11 of the charger (OBC) 10 is configured to monitor the CP signal to operate the controller (CPU) 12 in the charger (OBC), and the controller (CPU) 12 is configured to turn on a first power supply 13 to operate an internal circuit (OBC circuit) 14 for a charging operation.

As illustrated in FIG. 11, when the external controller 20 monitors the CP signal to turn on OBC power supply 31 which operates the controller of the charger (OBC) 30 and the internal circuit (OBC circuit) for the charging operation of the charger (OBC), the OBC power supply 31 is configured to operate the controller in the OBC and the internal circuit (OBC circuit) based on the state of the CP signal.

Hereinafter, an exemplary embodiment of the present invention will be described in detail with reference to the accompanying drawings.

A charging device for a vehicle according to an exemplary embodiment of the present invention is a charger mounted within a vehicle to charge a battery used as a power supply of a driving motor for a vehicle and is generally known as an on-board charger (OBC), and when an external power supply disposed extraneous to the vehicle (e.g., electric vehicle supply equipment (EVSE) is electrically connected thereto via a connector to charge the battery when an engine of the vehicle is turned off and a control pilot (CP) signal is applied from the electric vehicle supply equipment, a power supply of a first controller (OBC CPU) configured to operate the charger (OBC) may be turned on or off based on a property of the applied CP signal, thereby reducing the regular current consumption.

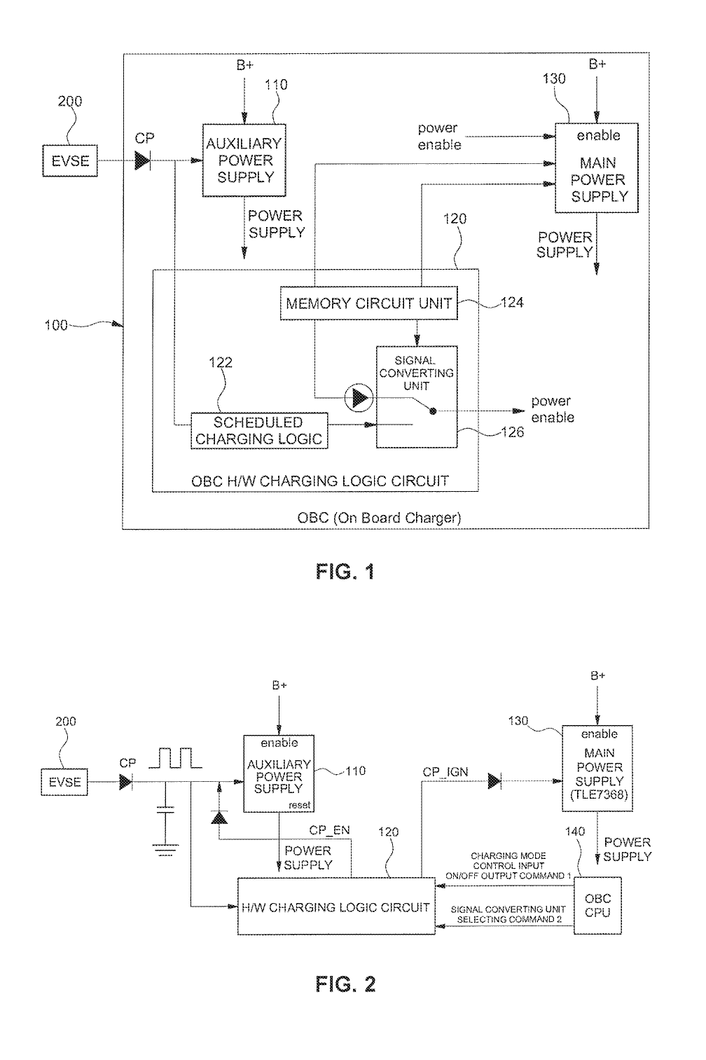

Accordingly, as illustrated in FIGS. 1 and 2, a charging device 100 for a vehicle according to an exemplary embodiment of the present invention may include a second power supply 110, a second controller 120, a first power supply 130, and a first controller 140. The second power supply 110 may be turned on when the CP signal is input from the external electric vehicle supply equipment 200 and supply power to the second controller 120 disposed within the charger (OBC).

The second controller 120 may be supplied with power from the second power supply 110 and may be configured to turn on the first power supply 130 at an initial operation to supply the power to the first controller 140. In other words, the first power supply 130 is a power supply configured to turn the first controller 140 on and off and supply the power to the first controller 140 during an on-operation to turn on the first controller 140.

The first controller 140 is a control circuit (CPU) that may be supplied with power from external electric vehicle supply equipment (EVSE) 200 when an engine of the vehicle is turned off to execute a charging operation of the charger (OBC) configured to charge a battery mounted within the vehicle, and the second controller 120 is a circuit configured to turn the first power supply 130 on and off based on the CP signal and a execute command signal of the first controller 140 and herein is referred to as a second controller to distinguish from the first controller 140 in the charger (OBC).

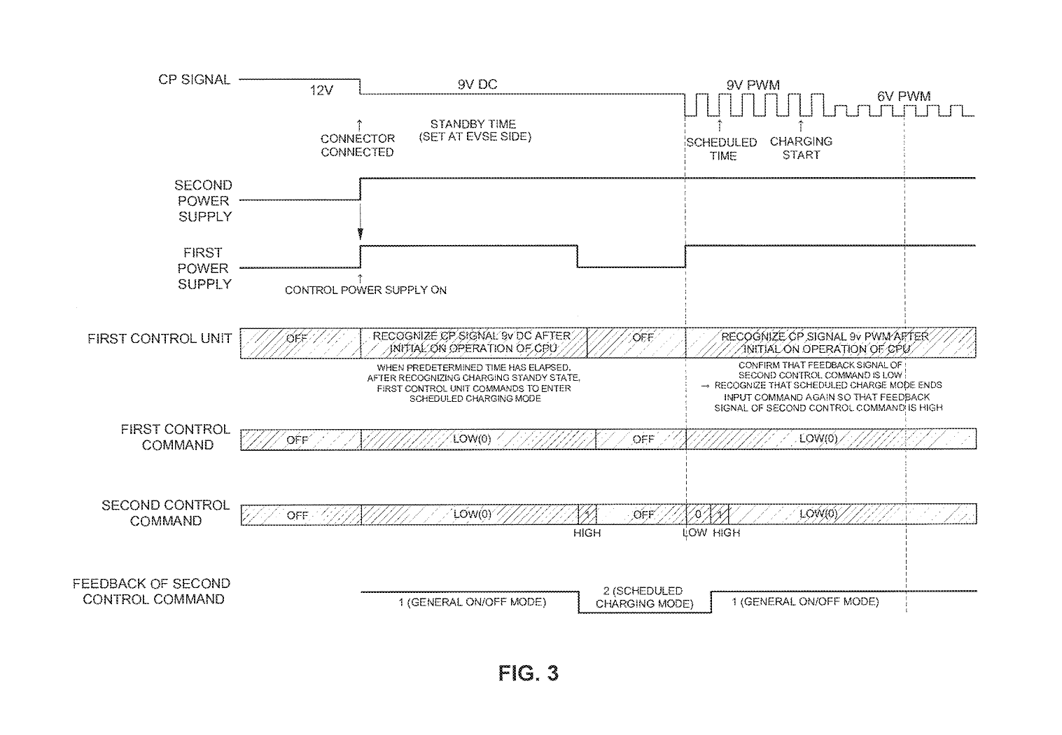

The charging device 100 according to the exemplary embodiment of the present invention with the above-described configuration, as illustrated in FIGS. 2 and 3, may be. connected to the external electric vehicle supply equipment (EVSE) 200 via a connector and then may enter a scheduled charging mode (or a charging standby mode) when the CP signal is input at a DC mode for a predetermined time or longer to maintain a standby state before entering a charging mode. When the scheduled charging time is reached after a standby time set in the electric vehicle supply equipment (EVSE) 200 elapses, the electric vehicle supply equipment (EVSE) 200 may receive the CP signal having a property of a square wave (e.g., a pulse width modulation (PWM) signal) to enter a charging mode to charge the battery.

In other words, when the CP signal is input from the external electric vehicle supply equipment (EVSE) 200 in a DC mode for a predetermined time or longer, the first controller 140 may be configured to determine that the charger (OBC) does not immediately enter the charging mode (e.g., does not immediately start charging the battery) but enters a scheduled charging mode to output a command signal (e.g., a signal which instructs to enter a scheduled charging mode) to turn off the first power supply 130, and the charger (OBC) may enter the scheduled charging mode. Thereafter, the CP signal may be applied with a property of a square wave to turn on the first power supply 130 again and the charger (OBC) may enter a charging mode.

When the charger (OBC) enters the charging mode, the charger (OBC) may be configured to charge a battery by the operation of the first controller 140. To accomplish the scheduled charging mode, the second controller 120 may be configured to simultaneously receive two command signals (e.g., control signals) from the first controller 140 and determine whether to turn off only the first power supply 130 or both the first power supply 130 and the second power supply 110 based on the input control signal.

In particular, the first controller 140 may be configured to input a control signal (e.g., a command signal) based on scheduled charging mode entry or charging completed mode. entry to the second controller 120, and the second controller 120 may be configured to turn the first power supply 130 on or off based on the control signal of the first controller 140.

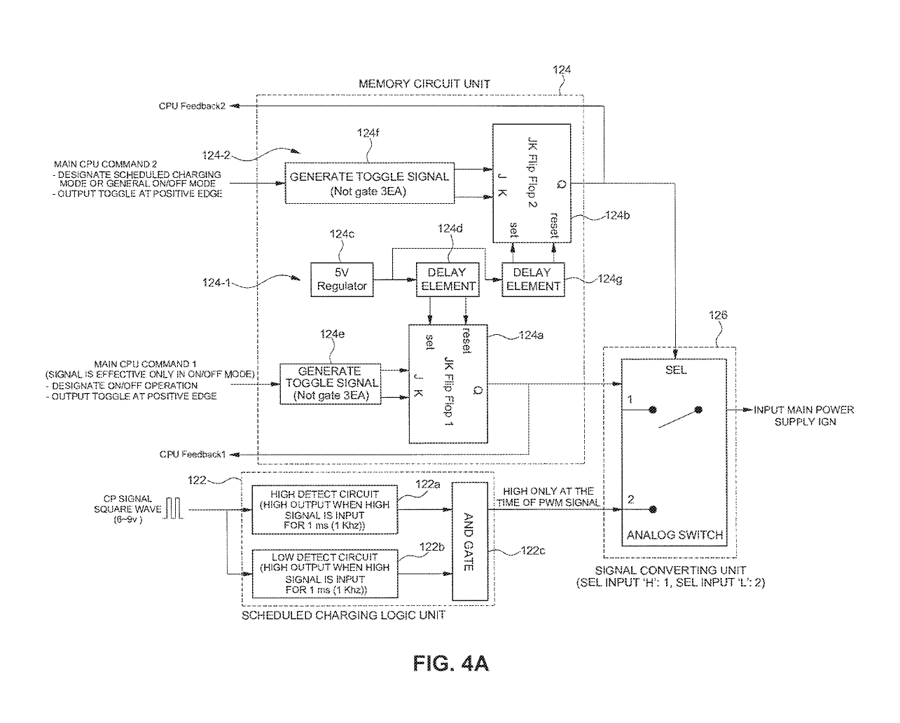

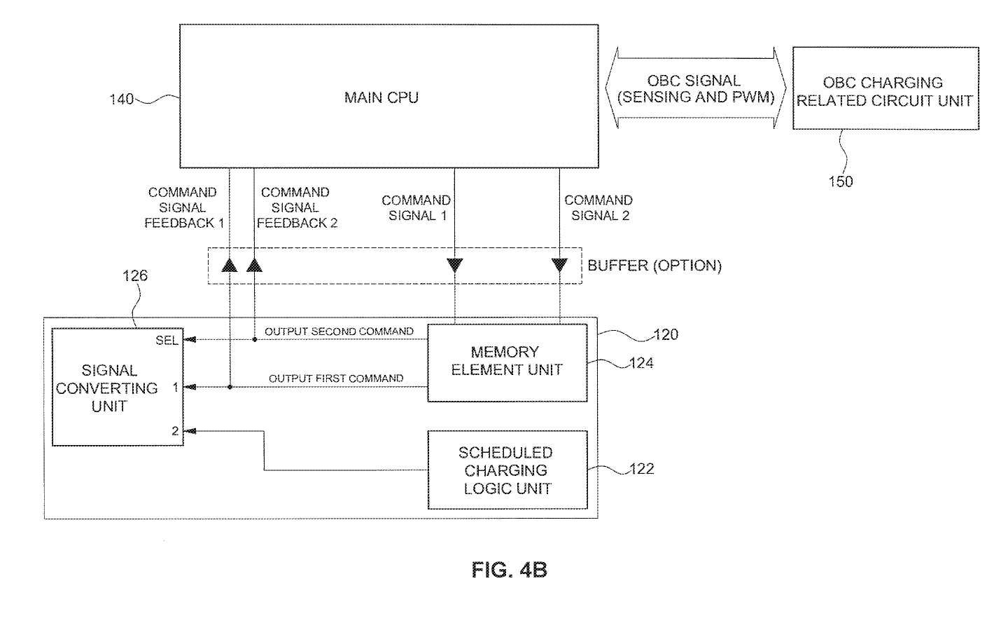

Hereinafter, a configuration and an operation of the second controller 120 built in the charger (OBC) will be described in more detail with reference to FIGS. 4A to 9.

As illustrated in FIG. 4A, the second controller 120 may include a scheduled charging logic unit 122, a memory circuit unit (e.g., a memory) 124, and a signal converting unit 126. The scheduled charging logic unit 122 may be configured to detect a property of an applied (input) CP signal and output a high (HIGH) signal (or an ON signal) to operate the first power supply 130 when a CP signal having a property of a square wave is input. When the CP signal is input, the scheduled charging logic unit 122 may be configured to output a. high output when the CP signal has the property of a square wave, using two signal detecting units 122a and 122b which detect signals in different states.

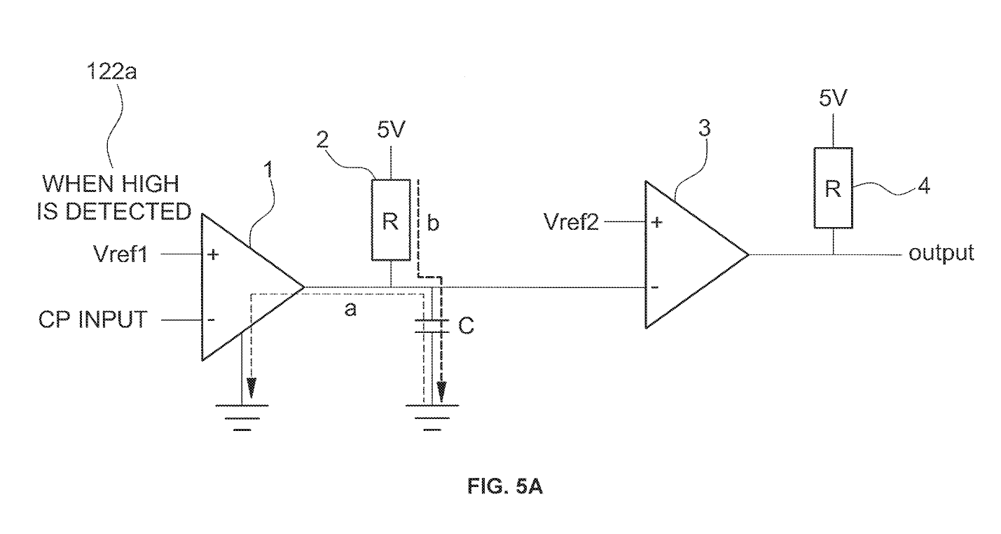

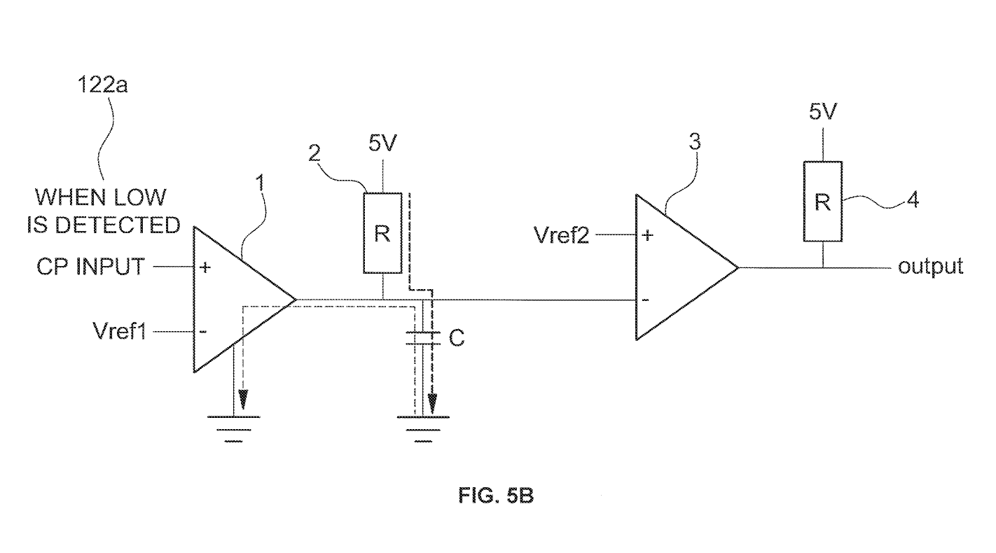

For example, as illustrated in FIG. 4A, the scheduled charging logic unit 122 may include a high signal detecting unit 122a configured to output a HIGH output when a HIGH signal (e.g., high signal of 1) of the CP signal is input, a low signal detecting unit 122b configured to output a HIGH output when a LOW signal (e.g. low signal of 0) of the CP signal is input, and an AND gate 122c configured to output a HIGH signal when both outputs of the high signal detecting unit 122a and the low signal detecting unit 122b are high. The high signal detecting unit 122a and the low signal detecting unit 122b may be configured as detecting circuits having a circuit configuration as illustrated in FIGS. 5A and 5B and the detailed description.

As illustrated in FIGS. 4A and 4B, the memory circuit unit 124 may be configured to receive a control signal from the first controller 140 to output a signal which executes a signal selecting (e.g., converting) operation of the signal converting unit 126 and a signal to turn the first power supply 130 on and off and may include a first command transmitting circuit unit 124-1 configured to receive a first control signal from the first controller 140 to output a signal for executing an on/off operation of the first power supply 130 and a second command transmitting circuit unit 124-2 configured to receive a second control signal from the first controller 140 to output a signal (e.g., high or low signal) for executing a signal selecting operation of the signal converting unit 126.

Particularly, the first command transmitting circuit unit 124-1 and the second. command transmitting circuit unit 124-2 may be configured using logic memory elements such as a latch or a flip flop. For example, the first command transmitting circuit unit 124-1 may be configured by a first flip flop 124a which may be activated when the CP signal is initially input to unconditionally output a high signal and then may be configured to operate by receiving the first control signal from the first controller 140.

In other words, the first command transmitting circuit unit 124-1 may include a regulator 124c turned on when the CP signal is input to activate the first flip flop 124a and a first flip flop 124a configured to receive the first control signal e.g., (a signal which designates an on/off operation of the first power supply) from the first controller 140 to output a signal which designates an output (e.g., an output to control the first power supply to be on/off) of the signal converting unit 126.

More specifically, the first command transmitting circuit unit 124-1 may include the regulator 124c turned on when the CP signal is input from the external electric vehicle supply equipment (EVSE) 200 to output a signal to activate the first flip flop 124a, a delay circuit unit 124d configured to delay input of an activating signal input to the first flip flop 124a when the regulator 124c is turned on to prevent an initial output of the first flip flop 124a from being output to be different from a setting value, and the first flip flop 124a configured to receive the first control signal from the first controller 140 to output a signal to designate an output of the signal converting unit 126.

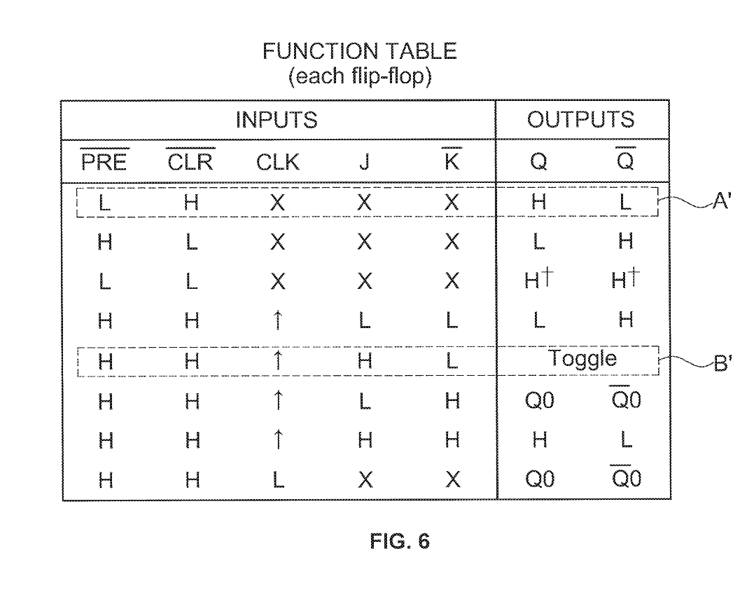

The first flip flop 124a may be applied with a CP signal from the outside to output a high signal at an initial operation (see A′ of FIG. 6) and then may be configured to receive the first control signal from the first controller 140 to output a signal that designates an output of the signal converting unit 126. In particular, a first toggle signal generating unit 124e may be mounted between the first controller 140 and the first flip flop 124a to reduce a load of the first controller 140. The first toggle signal generating unit 124e may be configured to receive one signal from the first controller 140 to generate and output two or three signals J, K, and CLK for operation of the first flip flop 124a. For example, the second command transmitting circuit unit 124-2 may include a second flip flop 124b set to be activated when the CP signal is initially input to unconditionally output a high signal and then may be configured to operate by receiving the second control signal from the first controller 140.

In other words, the second command transmitting circuit unit 124-2 may include a regulator 124c turned on when the CP signal is input from external electric vehicle supply equipment 200 to activate a second flip flop 124b and the second flip flop 124b configured to receive the second control signal from the first controller 140 to output a signal to execute a signal selecting operation of the signal converting unit 126.

More specifically, the second command transmitting circuit unit 124-2 may include the regulator 124c turned on when the CP signal is input from the external electric vehicle supply equipment (EVSE) 200 to output a signal to activate the second flip flop 124b, a delay circuit unit 124g configured to delay input of an activating signal input to the second flip flop 124b when the regulator 124c is turned on to prevent an initial output of the second flip flop 124b front being output to be different front a setting value, and the second flip flop 124b configured to receive the second control signal from the first controller 140 to output a signal to execute a signal selecting operation of the signal converting unit 126. Particularly, the first command transmitting circuit unit 124-1 and the second command transmitting circuit unit 124-2 may share one regulator 124c and as a result, the second controller 120 may be driven by the regulator 124c.

The second flip flop 124b may be applied with a CP signal from the outside to output a high signal at an initial operation (see A′ of FIG. 6) and then may be configured to receive the second control signal of the first controller 140 to output a signal to execute a signal selecting operation of the signal converting unit 126. In particular, a second toggle signal generating unit 124f may be mounted between the first controller 140 and the second flip flop 124b to reduce a load of the first controller 140. The second toggle signal generating unit 124f may be configured to receive one signal from the first controller 140 to generate and output two or three signals J, K, CLK for operation of the second flip flop 124b.

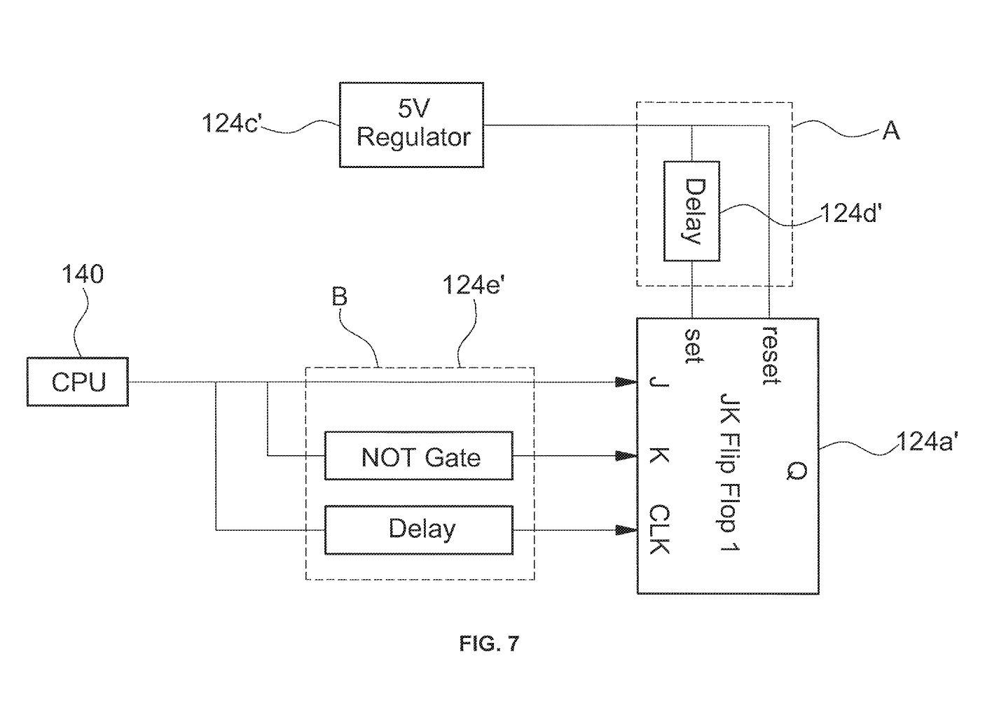

For example, the first command transmitting circuit unit 124-1 and the second command transmitting circuit unit 124-2 may be configured by the circuit configuration illustrated in FIG. 7. In FIG. 7, a connection structure of a circuit configured by a regulator 124c′, a delay circuit unit 124d′, a JK flip flop 124a′, and a toggle signal generating unit 124e′ is illustrated. Particularly, the delay circuit unit 124d′ may be configured to input a value (e.g., low and high) represented in A′ of FIG. 6 to the flip flop 124a′ and the toggle signal generating unit 124e′ may be configured to input a value represented in B′ of FIG. 6 to the flip flop 124a′. As a result, the JK flip flop 124a′ may be configured to output a high signal at an initial operation and toggle and output the control signal from the first controller 140 in a subsequent operation.

In addition, the first controller 140 may be configured to monitor an output of the JK flip flop (124a′, e.g., the first or second flip flop) and when the output is not a desired output value as a result of monitoring, so that when the first controller 140 converts the output into the desired output value, the first controller 140 may be configured to output a high signal (e.g., on signal) one time to toggle an output of the JK flip flop 124a′.

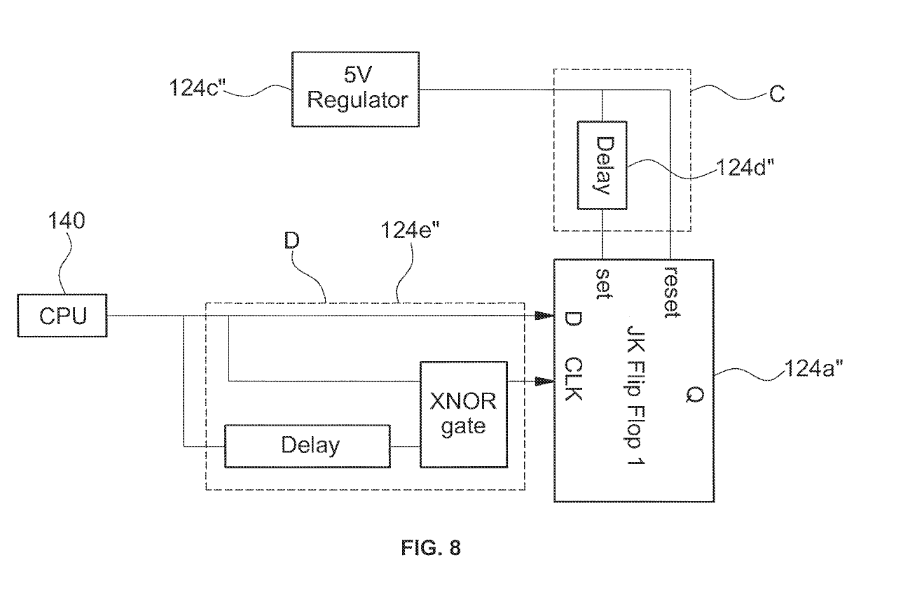

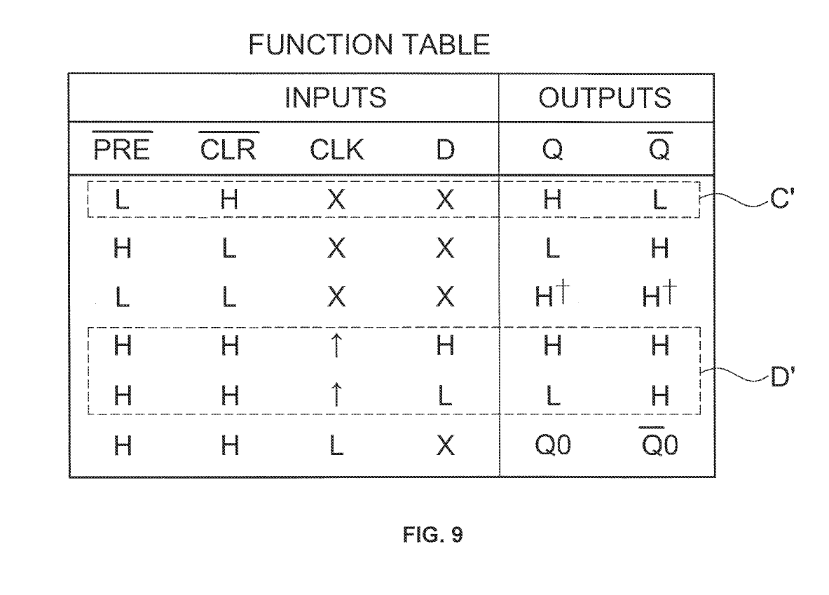

As another example, the first command transmitting circuit unit 124-1 and the second command transmitting circuit unit 124-2 may be configured by the circuit configuration illustrated in FIG. 8. In FIG. 8, a connection structure of a circuit configured by a regulator 124c″, a delay circuit unit 124d″, a D flip flop 124a″, and a toggle signal generating unit 124e″ is illustrated. In particular, the delay circuit unit 124d″ may be configured to input a value represented in C′ of FIG. 9 to the flip flop 124a″ and the toggle signal generating unit 124e″ may be configured to input a value represented in D′ of FIG. 9 to the flip flop 124a″. As a result, the D flip flop 124a″ may be configured to output a high signal at an initial operation and output a high or low signal based on the control signal of the first controller 140 in a subsequent operation. In particular, the first controller 140 does not need to monitor the output of the D flip flop 124a″.

The signal converting unit 126 may be configured to output a signal for executing an on/off operation of the first power supply 130 based on a signal input from the scheduled charging logic unit 122 and the memory circuit unit 124. Specifically, the signal converting unit 126 may be configured to receive two signals (e.g., one of them is a first signal) from the memory circuit unit 124 and one signal (e.g., a second signal) from the scheduled charging logic unit 122 and output one signal selected from the first signal and the second signal by a signal input from the second command transmitting circuit unit 124-2. When the first signal is selected, the signal converting unit 126 may be configured to output a signal input from the first command transmitting circuit unit 124-1 to execute an on/off operation of the first power supply 130 and when the second signal is selected, the signal converting unit 126 may be configured to output a signal input from the scheduled charging logic unit 122 to execute an on/off operation of the first power supply 130.

Therefore, a signal input from the first command transmitting circuit unit 124-1 is effective when the second command transmitting circuit unit 124-2 outputs a high signal, and a signal input from the scheduled charging logic unit 122 is effective when the second command transmitting circuit unit 124-2 outputs a low signal. The first controller 140 may be configured to monitor the signals of the first and second command transmitting circuit units 124-1 and 124-2 output to the signal converting unit 140 to use the signals as a determination reference for executing a subsequent operation.

An operating method of the second controller 120 configured as described above may be roughly divided into four steps and will be described as follows.

### First Step: When a CP Signal is Input

When the external electric vehicle supply equipment (EVSE) 200 is connected to the charger (OBC) 100 to input the CP signal from the electric vehicle supply equipment (EVSE), the second controller 120 may be supplied with power from the second power supply 110 to start art operation and in this case, the memory circuit unit 124 may be configured to output high signals from the first and second command transmitting circuit units 124-1 and 124-2 as previously set and the signal converting unit 126 which receives the high signals may be configured to turn on the first power supply 130.

In particular, the first flip flop 124a and the second flip flop 124b of the memory circuit unit 124 may be activated by the regulator 124c configured to receive the CP signal to output the previously set high signals (see an output value Q of FIG. 6 or 9) and an analog switch in the signal converting unit 126 configured to receive the high signals may be connected to the first command transmitting circuit unit 124-1 between the first command transmitting circuit unit 124-1 and the scheduled charging logic unit 122 to output an output (e.g., an output of the first flip flop) of the first command transmitting circuit unit 124-1 to turn on the first power supply 130.

The second power supply 110 may be unconditionally (always) maintained to be in an on-state under a condition where the output of the high signal detecting unit 122a is immediately monitored, to input the CP signal to the charger (OBC) 100. In other words, the second power supply 110 may be maintained in the on-state while the high signal detecting unit 122a outputs a high signal.

### Second Step: When Entering a Scheduled Charging Mode

The first controller 140 may be driven by the first power supply 130 turned on in the first step and the driven first controller 140 may be configured to determine whether the charger (OBC) enters a scheduled charging mode. The first controller 140 may be configured to confirm that the charger enters the scheduled charging mode by detecting that the first power supply 130 is maintained to be in the on-state for a predetermined time or longer.

When the control signal is not input from the first controller 140, the memory circuit unit 124 may be configured to maintain an output of the current state (e.g., an output of the current state may be maintained even when the first power supply 130 is turned off), and thus, when the external electric vehicle supply equipment (EVSE) 200 is connected to the charger (OBC) 100 and the CP signal is input in a DC mode for a predetermined time or longer, when the signal converting unit 126 of the second controller 120 maintains an output while being in a high state to maintain the on-state of the first power supply 130, the first controller 140 may be configured to confirm that the charger (OBC) enters the scheduled charging mode.

When the first controller 140 confirms that the charger (OBC) enters the scheduled charging mode, the first controller 140 may be configured to input a second control signal for a signal converting operation of the signal converting unit 126 to the second command transmitting circuit unit 124-2 and an analog switch in the signal converting unit 126 may be connected to the scheduled charging logic unit 122 to execute the operation of the first power supply 130 based on the output signal of the scheduled charging logic unit 122.

Since the CP signal has a property of a direct current in the scheduled charging mode state, the scheduled charging logic unit 122 may be configured to output a low signal and thus the signal converting unit 126 may be configured to output a low (e.g. off) signal and the first power supply 130 may be switched to be in an off state.

### Third Step: When Cancelling Scheduled Charging Mode and Entering Charging Mode

When a standby time set in the external electric vehicle supply equipment (EVSE) 200 has elapsed and a CP signal having a property of a square wave (e.g., PWM signal) is input from the electric vehicle supply equipment (EVSE), the scheduled charging logic unit 122 may be configured to output a high signal. In particular, since the analog switch in the signal converting unit 126 is connected to the scheduled charging logic unit 122, the signal converting unit 126 may be configured to output a high signal and thus the first power supply 130 may be switched to be in an on-state.

The first power supply 130 switched to be in the on-state may be configured to drive the first controller 140 again and the driven first controller 140 may be configured to operate the charging circuit unit (see reference numeral 150 of FIG. 4B) to execute the charging of an actual battery of the circuit in the charger (OBC) to charge the battery.

### Fourth Step: When Ending Charging Mode

When the first controller 140 detects that a battery charging operation of the charging circuit unit 150 within the charger (OBC) is completed, the first controller 140 may be. configured to monitor the output signal of the second command transmitting circuit unit 124-2 to detect whether an output of the second command transmitting circuit unit 124-2 is a high signal. When the output of the second command transmitting circuit unit 124-2 is a low signal, the first controller 140 may be configured to input a second control signal toggled to be inverted to the second command transmitting circuit unit 124-2 to allow the second command transmitting circuit unit 124-2 to output a high signal.

Further, the first controller 140 may be configured to input the first control signal to the first command transmitting circuit unit 124-1 to output a low signal from the first flip flop 124a of the first command transmitting circuit unit 124-1. Accordingly, the signal converting unit 126 may be configured to output a low signal based on the output of the first flip flop 124a and the first power supply 130 may be switched to be in an off-state.

Particularly, the memory circuit unit 124 may be configured to maintain an output of the second command transmitting circuit unit 124-2 to be in a high state and maintain the output of the first command transmitting circuit unit 124-1 to be in a low state to maintain the current output (e.g., low output) of the signal converting unit 126 until the input of the CP signal from the electric vehicle supply equipment (EVSE) 200 stops (e.g., is lost), in other words, until the input of the CP signal stops to stop the operations of the second power supply and the second controller 120. When the CP signal is not input, regulator 124c may be turned off and thus, the second command transmitting circuit unit 124-2 may be configured to output a low signal and the signal converting unit 126 may be configured to maintain the first power supply 130 to be in an off state and turn off the second power supply 110 by the output (e.g., low output) of the scheduled charging logic unit 122.

As described above, when the charging mode ends, the first controller 140 may be configured to output the output of the second command transmitting circuit unit 124-2 to be high by the second control signal to allow the signal converting unit 126 to select first signal (e.g., output of the first command transmitting circuit unit 124-1) as an input value and change the output (e.g., the first signal which is input to the signal converting unit 126) of the first command transmitting circuit unit 124-1 to be low by the first control signal to turn off the first power supply 130.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A charging device for a vehicle having a built-in circuit for embodying a scheduled charging function supplied with power from external electric vehicle supply equipment to charge a battery mounted the vehicle, the charging device comprising:
a first power supply;
a first controller;
a second power supply turned on when a control pilot (CP) signal is input from the electric vehicle supply equipment; and
a second controller configured to receive the power from the second power supply and operate the first power supply to be turned on or off,
wherein the first power supply is turned on by the second controller on the first controller, and
wherein the first controller is turned on by the first power supply and is configured to output a control signal to the second controller indicating whether to turn the first power supply on or off.

2. The charging device of claim 1, wherein the second controller includes:
a scheduled charging logic unit configured to detect a property of the CP signal input from the electric vehicle supply equipment to output a signal indicating whether to turn the first power supply on or off;
a memory circuit unit configured to receive a control signal from the first controller to output a signal for executing a signal selecting operation of a signal converting unit and a signal indicating whether to turn the first power supply on or off; and
a signal converting unit configured to receive an output signal of the scheduled charging logic unit and the memory circuit unit to output a signal indicating whether to turn the first power supply on or off.

3. The charging device of claim 2, wherein the memory circuit unit includes:
a first command transmitting circuit unit configured to receive a control signal of the first controller to output a signal for executing a signal selecting operation of the signal converting unit; and
a second command transmitting circuit unit configured to receive the control signal of the first controller to output a signal for executing the first power supply to be on/off.

4. The charging device of claim 3, wherein when the memory circuit unit initially operates, and the first command transmitting circuit unit and the second command transmitting circuit unit are set to output a high signal to the signal converting unit to turn on the first power supply.

5. The charging device of claim 3, wherein when the first power supply is maintained to be in an on state for a predetermined time or longer, the first controller is configured to input a control signal for allowing the signal converting unit to select an output signal of the scheduled charging logic unit to the second command transmitting circuit unit and the scheduled charging logic unit is configured to output a low signal based on the property of the CP signal.

6. The charging device of claim 2, wherein when the signal converting unit is connected to the scheduled charging logic unit and the CP signal with a property of a square wave is applied to allow the scheduled charging logic unit to output a high signal, wherein the signal converting unit is configured to output the high signal to turn on the first power supply.

7. The charging device of claim 2, wherein the scheduled charging logic unit is configured to output a high signal when the CP signal is a square wave, using a high signal detecting unit and a low signal detecting unit configured detect signals in different states when the CP signal is input.

8. The charging device of claim wherein the scheduled charging logic unit includes:
a high signal detecting unit configured to output a HIGH output when a HIGH signal of the CP signal is input;
a low signal detecting unit configured to output a HIGH output when a LOW signal of the CP signal is input; and
an AND gate configured to output a HIGH signal when both outputs of the high signal detecting unit and the low signal detecting unit are high.

9. The charging device of claim 3, wherein the signal converting unit is configured to select any one of an output signal of the second command transmitting circuit unit and an output signal of the scheduled charging logic unit by a signal input from the first command transmitting circuit unit and output a signal for an on/off operation of the first power supply by the selected output signal.
